(19) United States
(12) Patent Application Publication
(10) Pub. No.: US 2009/0140988 A1
(43) Pub. Date: Jun. 4, 2009

(54) Touch Panel with Integrated Function Keys

(76) Inventors: Carl Thelemann, East Islip, NY (US); Thomas Wulff, North Patchogue, NY (US); Carl Degiovine, Shirley, NY (US)

Correspondence Address: Fay Kaplun & Marcin, LLP/ Motorola, 150 Broadway Suite 702, New York, NY, 10038, US

(21) Appl. No.: 11/949,996

(22) Filed: Dec. 4, 2007

(51) Int. Cl. G06F 3/045

(52) U.S. Cl. 345/173

(57) ABSTRACT

A mobile unit comprises a housing, a display, and a touch panel. The display is at least partially dispose within the housing. The touch panel is disposed at least partially over at least a portion of the display receiving touch inputs. The touch panel is configured to incorporate a plurality of function keys. The plurality of function keys are disposed substantially around a perimeter of the display.

### FIELD OF THE INVENTION

The present invention relates generally to a touch panel with integrated function keys. Specifically, the function keys are disposed along edges of the touch panel around an area of display.

### BACKGROUND

A mobile unit (MU) may be equipped with various kinds of data input arrangements. The data input arrangement may be configured to have at least a key pad disposed on a face of a housing of the MU where the face is a common surface in which a display is disposed. The keypad may be, for example, a QWERTY keypad, a numeric keypad, an alphanumeric keypad, etc. To facilitate a use of shortcuts, the data input arrangement may include function keys (e.g., F-keys on a keyboard). The function keys may be located with the keypad.

Removing the function keys from the keypad and relocating them around a perimeter of the display of the MU enables the function keys to be aligned, allows use in conjunction with the display graphics, simplifies the keypad layout, etc. However, when relocating the function keys around the perimeter of the display, the overall product size (e.g., width and length) may be impacted by increasing the size of the housing of the MU simply to place the function keys. Furthermore, an overall cost of the MU increases as additional circuits are necessary. In addition, manufacturing issues arise such as assembling the additional function key components.

### SUMMARY OF THE INVENTION

The present invention relates to a mobile unit comprising a housing, a display, and a touch panel. The display is at least partially dispose within the housing. The touch panel is disposed at least partially over at least a portion of the display receiving touch inputs. The touch panel is configured to incorporate a plurality of function keys. The plurality of function keys are disposed substantially around a perimeter of the display.

### DESCRIPTION OF THE DRAWINGS

FIG. 1 shows a mobile unit according to an exemplary embodiment of the present invention.

FIG. 2 shows an exploded view of a first touch panel arrangement to be used with the mobile unit of FIG. 1 according to an exemplary embodiment of the present invention.

FIG. 3 shows an exploded view of a second touch panel arrangement to be used with the mobile unit of FIG. 1 according to an exemplary embodiment of the present invention.

FIG. 4 shows an exploded view of a third touch panel arrangement to be used with the mobile unit of FIG. 1 according to an exemplary embodiment of the present invention.

FIG. 5 shows an assembled view of the mobile unit of FIG. 1 with one of the touch panel arrangements of FIGS. 2-4 according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a mobile unit (MU) in which the display is coupled to a touch panel with integrated function keys. Specifically, the exemplary embodiments of the present invention may integrate the function keys within an area of the touch panel to eliminate a need for altering a housing of the MU to include the function keys. The MU, the touch panel, and the function keys will be discussed in more detail below.

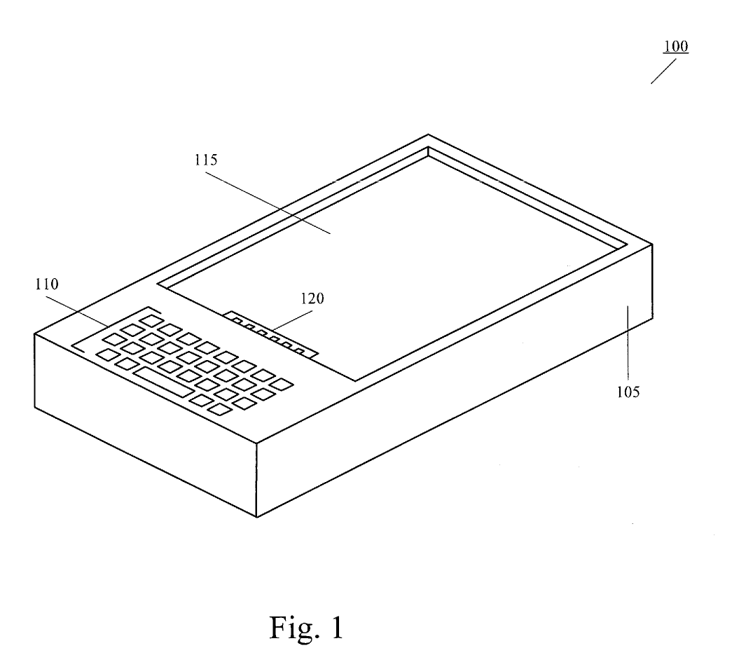

FIG. 1 shows a mobile unit (MU) 100 according to an exemplary embodiment of the present invention. The MU 100 may be any portable electronic device that utilizes a portable power supply (e.g., battery, capacitor, super capacitor, etc.). For example, the MU 100 may include a mobile computer; a personal digital assistant (PDA); a laptop; a pager; a cell phone; a data acquisition device such as a radio frequency identification reader, a scanner, and an image capturing device; etc. It should be noted that the use of the MU 100 is only exemplary. The exemplary embodiments of the present invention may also be applied to any electronic device such as those that are not portable or a stationary device. For example, an electronic device with a display that is connected to a desktop computer is not portable but may still utilize the exemplary embodiments of the present invention.

As will be discussed in further detail below, various configurations of touch panels may be coupled to the MU 100. Thus, the MU 100 may be a base unit in which the touch panel may be coupled. The MU 100 may include a housing 105, a data input arrangement 110, a display 115, and a plurality of contacts 120.

The housing 105 may provide a casing in which components of the MU 100 may be at least partially disposed. That is, the components of the MU 100 may be wholly or partially within the housing 105. For example, the MU 100 may include a processor, a memory, a transceiver, etc. These components may be entirely disposed within the housing 105. In another example, the data input arrangement 110, the display 115, the contacts 120, etc. may be disposed partially within the housing 105 so that a portion of these components are disposed on or outside of a periphery of the housing 105.

The data input arrangement 110 may be a user interface. Specifically, the user interface may be a keypad in which a user may enter various inputs. The keypad may have, for example, a QWERTY configuration, a numeric configuration, an alphanumeric configuration, etc. The inputs may be used for at least one installed program or functionality of the MU 100.

The display 115 may be a graphical user interface so that a user may view data relating to a program or functionality of the MU 100 visually. The display 115 may be a liquid crystal display (LCD) so that the display 115 may be sized according to the MU 100. The display 115 may include a viewable surface that is less than the exposed surface shown in FIG. 1. As will be described in detail below, the viewable surface of the display 115 may be formatted so that peripheral edges of the exposed surface are not included in the viewable surface.

The contacts 120 may provide a connection between the display and other components of the MU 100. The contacts 120 may be, for example, receptacles to receive corresponding pins, flat contacts, pins to be received by corresponding receptacles, etc. For example, as illustrated, the contacts 120 include six contacts. However, it should be noted that the contacts 120 may include at least one contact.

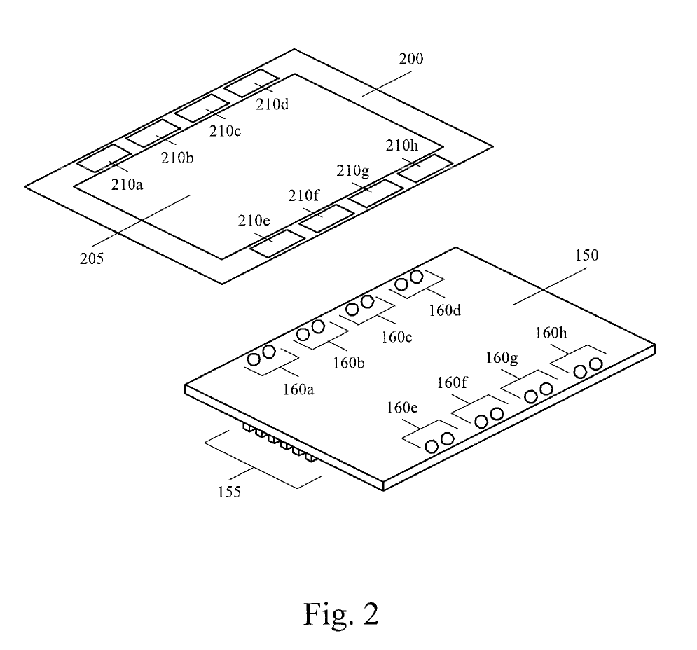

FIG. 2 shows an exploded view of a first touch panel arrangement to be used with the MU 100 of FIG. 1 according to an exemplary embodiment of the present invention. The first touch panel arrangement may be coupled to the MU 100 of FIG. 1. Specifically, the first touch panel arrangement may be disposed over the display 115. The first touch panel arrangement includes a touch panel 150 and an overlay 200.

The touch panel 150 may be a transparent surface that is configured to receive touch inputs thereon. The touch panel 150 may be of any kind such as a resistive touch panel, a surface acoustic wave (SAW) touch panel, a capacitive touch panel, an infrared touch panel, a strain gauge touch panel, an optical imaging touch panel, etc. According to the exemplary embodiments of the present invention, the touch panel 150 may be disposed over the display 115. The transparency of the touch panel 150 may enable a user to view the data shown on the display 115. The touch panel 150 may also function in conjunction with the display 115. A perimeter of the touch panel 150 may have electrical traces running around it. The traces may exit through the panel contacts 155 so that the signals from the traces may be received, for example, by the processor of the MU 100. In another embodiment, the traces may exit through a flex that extends from the touch panel 150. The flex may be configured to couple to the contacts 120. The touch panel 150 includes a plurality of panel contacts 155 and a plurality of snap domes 160a-h.

The panel contacts 155 may correspond to the contacts 120 of the MU 100. That is, the panel contacts 155 may be coupled to the contacts 120 to form the electrical connection between certain components of the MU 100 and the touch panel 150. Accordingly, depending on the form of the contacts 120 (e.g., pins, receptacles, flat contacts, etc.), the panel contacts 155 may exhibit a respective form. As illustrated, the panel contacts 155 may be pins that are received the contacts 120 that are receptacles.

The snap domes 160a-h may be input receivers. Specifically, each of the snap domes 160a-h may be temporarily depressed to complete a circuit, thereby activating the input. Once released, the snap dome may return to an original state where the circuit is open. As illustrated, each of the snap domes 160a-h may be a pair of snap domes. However, it should be noted that the use of the pair of snap domes is only exemplary. In other embodiments, each of the snap domes 160a-h may be a single snap dome. It should also be noted that the use of snap domes is only exemplary. The input receivers may also be, for example, metal domes, poly-domes, etc. As will be explained further below, the snap domes 160a-h may be the function keys.

The snap domes 160a-h may be disposed around a periphery of the touch panel 150. Specifically, as illustrated, four pairs of snap domes are disposed on longitudinal sides of the touch panel 150. The snap domes 160a-d are disposed on a first longitudinal side while the snap domes 160e-h are disposed on a second longitudinal side. It should be noted that the snap domes 160a-d may further be disposed on lateral sides.

The touch panel 150 may include a receptive area (i.e., an area that enables touch inputs to be received) that is centralized so that an outer area is not receptive to touch inputs. Specifically, the outer area may have dimensions corresponding to a slightly larger distance than a diameter of one of the snap domes 160a-h. However, it should be noted that in other embodiments, the entire touch panel 150 may include the receptive area.

The overlay 200 may be applied over the touch panel 150. Specifically, the overlay 200 may cover the snap domes 160a-h, thereby hiding the snap domes 160a-h. Outer dimensions of the overlay 200 may correspond to outer dimensions of the touch panel 150. The overlay 200 may include a via 205. The via 205 prevents a blocking of a view of the display 115 which is viewed through the transparent touch panel 150. According to the exemplary embodiments of the present invention, the overlay 200 is not transparent and has graphics imprinted thereon. The graphics may include function key graphics 210a-h. Each of the function key graphics 210a-h may include a viewable descriptor. For example, because the function key graphics 210a-h represent function keys, the descriptor may be F1-8, respectively. When in a proper orientation each of the function key graphics 210a-h are disposed over one of the snap domes 160a-h. For example, the function key graphic 210a is disposed over the snap dome 160a; the function key graphic 210b is disposed over the snap dome 160b; the function key graphic 210c is disposed over the snap dome 160c; etc.

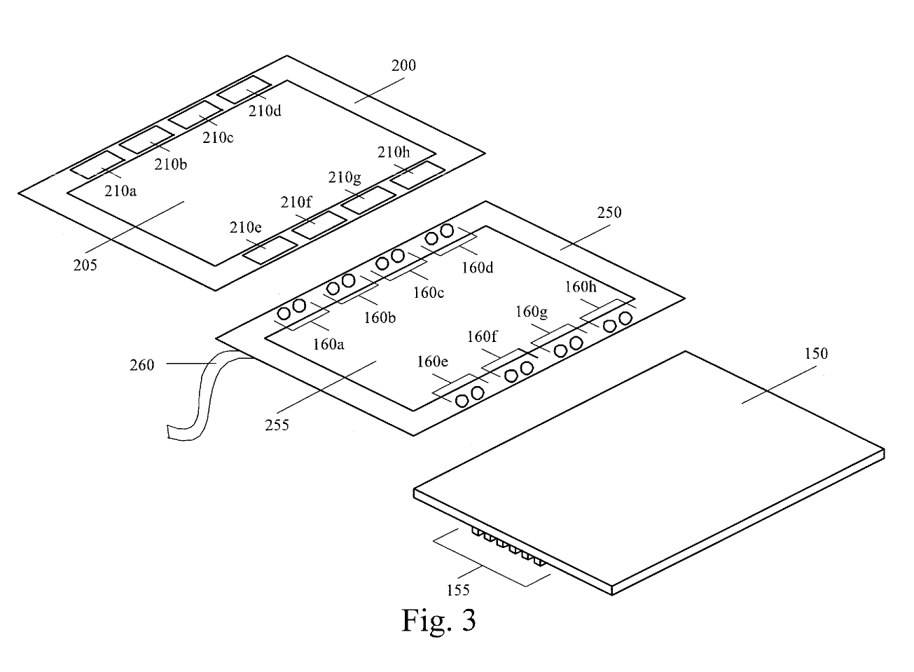

FIG. 3 shows an exploded view of a second touch panel arrangement to be used with the MU 100 of FIG. 1 according to an exemplary embodiment of the present invention. The second touch panel arrangement may also be coupled to the MU 100 of FIG. 1. Specifically, the second touch panel arrangement may be disposed over the display 115. The second touch panel arrangement includes the touch panel 150, the overlay 200, and a flex layer 250.

The touch panel 150 of the second touch panel arrangement may be substantially similar to the touch panel 150 of the first touch panel arrangement. Specifically, the touch panel 150 of the second touch panel arrangement may be transparent, receive touch inputs, disposed over the display 115, and be any of the types of touch panels listed above. The touch panel 150 may also include the panel contacts 155 that couple to the contacts 120 of the MU 100. The touch panel 150 may also include a receptive area is partially or entirely comprised of the exposed surface of the touch panel 150.

The flex layer 250 may be disposed between the touch panel 150 and the overlay 200. The flex layer 250 may include a via 255 so that a user may view the data of the display 115 through the touch panel 150. In another embodiment, the flex layer 250 may be a transparent layer so that the data may be viewed. In this embodiment, the flex layer 250 may be configured so that touch inputs received thereon are transferred to the touch panel 150.

The flex layer 250 may include the snap domes 160a-h. The snap domes 160a-h may be configured on the flex layer 250 in a substantially similar manner as they were configured on the touch panel 150 illustrated in FIG. 2 (e.g., snap domes 160a-d are disposed on a first longitudinal side while snap domes 160e-h are disposed on a second longitudinal side). The flex layer 250 may include a flex 260 so that an electrical connection is established between the flex layer 250 and the MU 100. The flex 260 may couple with another set of contacts (not shown) on the MU 100. In another embodiment, the flex layer 250 may couple with the touch panel 150 so that the panel contacts 155 may be used to establish the electrical connection between the MU 100 and the touch panel 150/the flex layer 250.

The overlay 200 of the second touch panel arrangement may be substantially similar to the overlay 200 of the first touch panel arrangement. Specifically, the overlay 200 may cover the snap domes 160a-h, may exhibit dimensions corresponding to the dimensions of the touch panel 150, include the via 205, and have function key graphics 210a-h imprinted thereon. However, in this exemplary embodiment of the second touch panel arrangement, the overlay 200 is disposed over the flex layer 250 instead of directly over the touch panel 150.

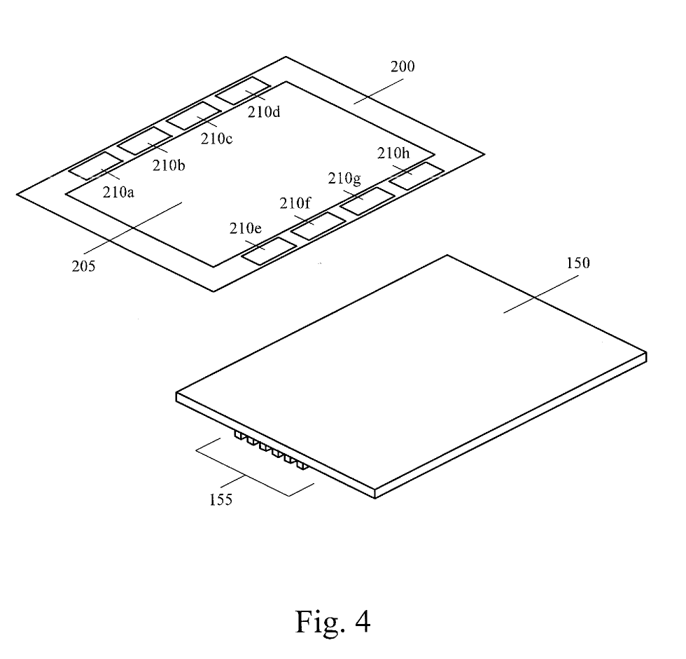

FIG. 4 shows an exploded view of a third touch panel arrangement to be used with the MU 100 of FIG. 1 according to an exemplary embodiment of the present invention. The third touch panel arrangement may also be coupled to the MU 100 of FIG. 1. Specifically, the third touch panel arrangement may be disposed over the display 115. The third touch panel arrangement includes the touch panel 150 and the overlay 200.

The touch panel 150 of the third touch panel arrangement may be substantially similar to the touch panel 150 of the first touch panel arrangement. Specifically, the touch panel 150 of the second touch panel arrangement may be transparent, receive touch inputs, disposed over the display 115, and be any of the types of touch panels listed above. The touch panel 150 may also include the panel contacts 155 that couple to the contacts 120 of the MU 100. However, in this exemplary embodiment of the third touch panel arrangement, a receptive area of the touch panel 150 may be the entire exposed surface of the touch panel 150.

The overlay 200 of the third touch panel arrangement may be substantially similar to the overlay 200 of the first touch panel arrangement. Specifically, the overlay 200 may exhibit dimensions corresponding to the dimensions of the touch panel 150, include the via 205, and have function key graphics 210a-h imprinted thereon. However, in this exemplary embodiment of the third touch panel arrangement, the overlay 200 is disposed directly over the touch panel 150. The touch panel 150 is configured so that defined areas of the touch panel 150 that are disposed under one of the function key graphics 210a-h corresponds to the function key functionality. That is, the third touch panel arrangement does not necessitate a need for the snap domes 160a-h. If and when adjacent areas around the defined areas of the touch panel 150 are activated, the input may be cancelled by the processor of the MU 100.

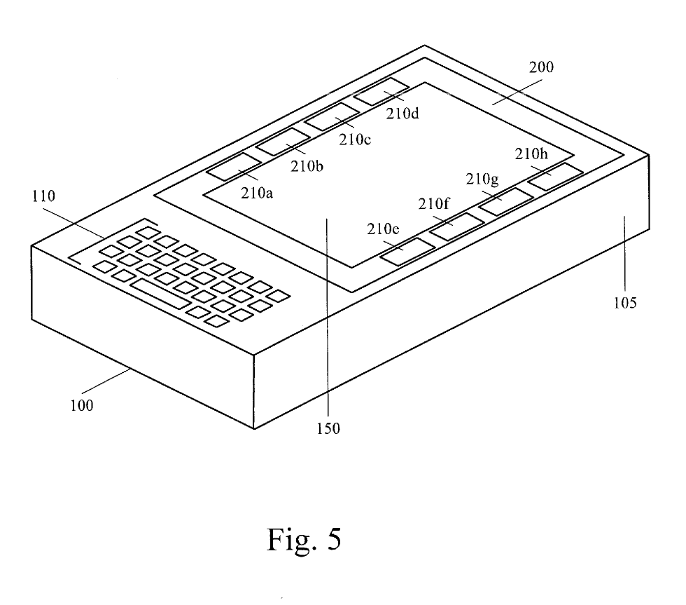

FIG. 5 shows an assembled view of the MU 100 of FIG. 1 with one of the touch panel arrangements of FIGS. 2-4 according to an exemplary embodiment of the present invention. As discussed above, the MU 100 may be a base unit that couples with any of the touch panel arrangements described above with reference to FIGS. 2-4. Independent of the arrangement that is coupled to the MU 100, the coupled unit may exhibit a substantially similar configuration as illustrated in FIG. 5. Specifically, the MU 100 couples with the touch panel arrangement so that the overlay 200 is disposed over the touch panel 150 which is disposed over the display 115.

When coupled, the panel contacts 155 of the touch panel 150 couple with the contacts 120 of the MU 100. With respect to the third touch panel arrangement, the flex 260 may also couple with another set of contacts of the MU 100 or couple to the touch panel 150 and be connected to the MU 100 via the panel contacts 155. The via 205 of the overlay 200 provides a window to view data of the display 115 through the touch panel 150.

In the assembled view, the function key graphics 210a-h are visible. Thus, a user may identify a location that must be pressed so that the function key functionality is activated. Therefore, in combination with the data input arrangement 110, function keys may be disposed with the MU 100 around an area of the display 115 without increasing an overall size of the MU 100 nor require any additional components or manufacturing steps.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile unit, comprising:
a housing;
a display at least partially disposed within the housing; and
a touch panel disposed at least partially over at least a portion of the display receiving touch inputs, the touch panel configured to incorporate a plurality of function keys, the plurality of function keys disposed substantially around a perimeter of the display.

2. The mobile unit of claim 1, further comprising:
an overlay disposed over the touch panel.

3. The mobile unit of claim 2, further comprising:
a plurality of input receivers for each of the plurality of function keys disposed on one of the touch panel and a flex layer disposed between the touch panel and the overlay.

4. The mobile unit of claim 3, wherein the overlay includes predetermined graphics thereon, each of the graphics disposed over a corresponding one of the plurality of input receivers.

5. The mobile unit of claim 3, wherein the input receivers are one of snap domes, metal domes, and poly-domes.

6. The mobile unit of claim 3, wherein the flex layer is electrically coupled to one of the touch panel and a connector of the mobile unit.

7. The mobile unit of claim 2, wherein defined areas of the touch panel are configured to represent each of the plurality of function keys.

8. The mobile unit of claim 7, wherein the overlay includes predetermined graphics thereon, each of the graphics disposed over a corresponding one of the predefined areas.

9. The mobile unit of claim 7, wherein inputs received on adjacent areas of the defined areas are cancelled.

10. The mobile unit of claim 1, further comprising:
a data input arrangement disposed at least partially within the housing.

11. A touch panel arrangement, comprising:
a touch panel configured to receive touch inputs, the touch panel disposed at least partially over at least a portion of a display; and
a plurality of function keys incorporated in the touch panel, the plurality of function keys disposed substantially around a perimeter of the display.

12. The touch panel arrangement of claim 11, further comprising:
an overlay disposed over the touch panel.

13. The touch panel arrangement of claim 12, further comprising:
a plurality of input receivers for each of the plurality of function keys disposed on one of the touch panel and a flex layer disposed between the touch panel and the overlay.

14. The touch panel arrangement of claim 13, wherein the overlay includes predetermined graphics thereon, each of the graphics disposed over a corresponding one of the plurality of input receivers.

15. The touch panel arrangement of claim 13, wherein the input receivers are one of snap domes, metal domes, and poly-domes.

16. The touch panel arrangement of claim 13, wherein the flex layer is electrically coupled to one of the touch panel and a connector of the mobile unit.

17. The touch panel arrangement of claim 12, wherein defined areas of the touch panel are configured to represent each of the plurality of function keys.

18. The touch panel arrangement of claim 17, wherein the overlay includes predetermined graphics thereon, each of the graphics disposed over a corresponding one of the predefined areas.

19. The touch panel arrangement of claim 17, wherein inputs received on adjacent areas of the defined areas are cancelled.

20. A mobile unit, comprising:
a housing;
a display means for displaying data, the display means at least partially disposed within the housing; and
a touch receptive for receiving touch inputs, the touch receptive means disposed at least partially over at least a portion of the display means, the touch receptive means configured to incorporate a plurality of function keys, the plurality of function keys disposed substantially around a perimeter of the display means.
